(19) United States
(12) Patent Application Publication
(10) Pub. No.: US 2024/0150177 A1
(43) Pub. Date: May 9, 2024

(54) SYNTHESIS OF CATHODE MATERIAL FOR LITHIUM BATTERY

(71) Applicants: Qatar Foundation for Education, Science and Community Development, Doha (QA); Qatar University, Doha (QA)

(72) Inventors: Abdul Shakoor, Doha (QA); Umair Nisar, Doha (QA); Zawar Qureshi, Doha (QA); Jeffin Abraham, Doha (QA); Khadija Muhammad Abdul Quddus, Doha (QA); Siham AlQaradawi, Doha (QA); Ramazan Kahraman, Doha (QA)

(73) Assignee: Qatar University, Doha (QA)

(21) Appl. No.: 18/387,301

(22) Filed: Nov. 6, 2023

Related U.S. Application Data
(60) Provisional application No. 63/423,325, filed on Nov. 7, 2022.

(51) Int. Cl. C01B 25/455; H01M 4/58

(52) U.S. Cl. CPC C01B 25/455; H01M 4/582; H01M 4/5825; C01P 2002/72; C01P 2002/85; C01P 2004/03; C01P 2006/40

(57) ABSTRACT

A synthesis method of cathode material for lithium battery is provided. The method includes dissolving lithium, nickel and cobalt acetate in a solution, adding ammonium dihydrogen phosphate to the solution, adding acid to the solution, heating the solution to a first temperature for a first period of time to form a solid mixer material, and sintering the solid mixer material at a second temperature for a second period of time.

### CROSS REFERENCE TO RELATED APPLICATIONS

The This application claims the benefit of U.S. Provisional Application No. 63/423,325 filed Nov. 7, 2022, which is incorporated herein by reference in its entirety.

### BACKGROUND

Li-ion battery technology is an integral discovery for current energy storage applications due to its strategic role in many electrical appliances. Li-ion batteries are used in various applications, from small-scale mobile phones to large-scale electric vehicles (E.V.) and Grid storage. As a requirement for shifting from our reliance on fossil fuels to other renewable energy sources, there is currently a huge demand for energy storage systems that can facilitate more power and energy density. The Li-ion battery still lacks energy and power density requirements. To develop new batteries for electric vehicles for longer driving ranges, contemporary materials with higher capacity, or that can be operated at higher voltage, need to be developed. Commercialized cathode materials such as LiNi_{1-x-y}MnₓCo_{y}O₂ (NCM) and LiNi_{0.8}Co_{0.15}Al_{0.5}O₂ (NCA) work at around 3.7 V vs. Li/Li+ and therefore are limited in energy density. However, high energy and power density limitations can be overcome with the development of high capacity and high voltage cathodes. Thus, high capacity and high voltage cathode material for lithium battery is desired.

### SUMMARY

According to one non-limiting aspect of the present disclosure, an exemplary embodiment of a synthesis method of cathode material for lithium battery is provided. In one embodiment, the method includes dissolving lithium, nickel and cobalt acetate in a solution, adding ammonium dihydrogen phosphate to the solution, adding acid to the solution, heating the solution to a first temperature for a first period of time to form a solid mixer material, and sintering the solid mixer material at a second temperature for a second period of time.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 shows a) a flowchart and b) a schematic of the synthesis process of Li₂CoₓNi₁₋ₓPO₄F (X<1), according to an example embodiment of the present disclosure.

FIG. 2 shows XRD patterns for phase pure Li₂NiPO₄F, according to an example embodiment of the present disclosure.

FIG. 3 shows XRD patterns for a) phase pure precursor material and b) Li₂CoₓNi₁₋ₓPO₄F (x<1), according to an example embodiment of the present disclosure.

FIG. 4 shows a) Rietveld refinement XRD pattern and crystal structure (inset) for Li₂NiPO₄F and b) proposed crystal structure for Li₂CoₓNi₁₋ₓPO₄F (x<1) cathode materials, according to an example embodiment of the present disclosure.

FIG. 5 shows SEM micrographs illustrating the polyhedral morphology of the Li₂NiPO₄F, according to an example embodiment of the present disclosure.

FIG. 6 shows a) SEM micrographs illustrating the polyhedral morphology of Li₂Co_{1/2}Ni_{1/2}PO₄F, b) TEM micrograph, c) Lattice Fringes, and d) SAED pattern for Li₂Co_{1/2}Ni_{1/2}PO₄F, according to an example embodiment of the present disclosure.

FIG. 7 shows a) EDX analysis of the synthesized Li₂NiPO₄F cathode material, b) FTIR Spectra of the synthesized Li₂NiPO₄F cathode material, and c) TGA curves of Li₂NiPO₄F with 10° C. min⁻¹ heating rate and under steady nitrogen-flow, according to an example embodiment of the present disclosure.

FIG. 8 shows a) EDX analysis of the synthesized Li₂Co_{1/2}Ni_{1/2}PO₄F cathode material, b) FTTR Spectra of the synthesized Li₂Co_{1/2}Ni_{1/2}PO₄F cathode material, and c) TGA curves of Li₂CoₓNi₁₋ₓPO₄F (x<1) cathode materials with 10° C. min⁻¹ heating rate and under steady nitrogen-flow, according to an example embodiment of the present disclosure.

FIG. 9 shows graphs illustrating galvanostatic charge-discharge behavior of the Li₂CoₓNi₁₋ₓPO₄F (x<1) cathode materials at C/20 rate with Celgard 2325 separator, according to an example embodiment of the present disclosure.

FIG. 10 shows graphs showing galvanostatic charge-discharge behavior of the Li₂CoₓNi₁₋ₓPO₄F (x<1) cathode materials at C/20 rate with Whatman Glass Fibre (GF/D) separator, according to an example embodiment of the present disclosure.

FIG. 11 shows cycling behavior comparison of Li₂CoₓNi₁₋ₓPO₄F (x<1) cathode materials at C/20 rate between a) Celgard 2325 separator and b) Whatman Glass Fibre (GF/D) separator, according to an example embodiment of the present disclosure.

### DETAILED DESCRIPTION

The present disclosure generally relates to a synthesis method of cathode material for lithium battery.

It is challenging to synthesize phase pure Li₂NiPO₄F due to instability of this phase at low temperatures, which results in decomposition into the LiNiPO₄ phase. Li₂NiPO₄F cathode has the potential for the next-generation high energy and power density lithium-ion batteries. The Disclosed Invention proposes and designs an easy and scalable synthesis of pure phase material. Furthermore, the Disclosed Invention is a Cobalt substituted cathode material Li₂CoₓNi₁₋ₓPO₄F (x<1) suitable for operation at high voltages. With this process, the Disclosed Invention aims to achieve ease of synthesizing phase pure Li₂NiPO₄F and Li₂CoₓNi₁₋ₓPO₄F (x<1) material to utilize its potential in high-powered applications.

Li₂NiPO₄F cathode material has a potential for future high energy and power density lithium-ion batteries due to its high operating voltage, also known as 6 V cathode material. Until now, the phase pure Li₂NiPO₄F has not been reported, and to fully translate this material into future batteries, an easy and scalable process to synthesize this material is the first step towards commercialization.

According to an embodiment of the present disclosure, a synthesis method for cathode material is provided. The synthesis method includes an easy and scalable sol-gel process to synthesize phase pure Li₂NiPO₄F material. Additionally, the present disclosure investigates the substitution of Co into the transition metal layer of Li₂NiPO₄F, thereby fabricating a mixed transition metal fluorophosphate material, Li₂CoₓNi₁₋ₓPO₄F (x<1), capable of sustaining high voltage charge-discharge behavior.

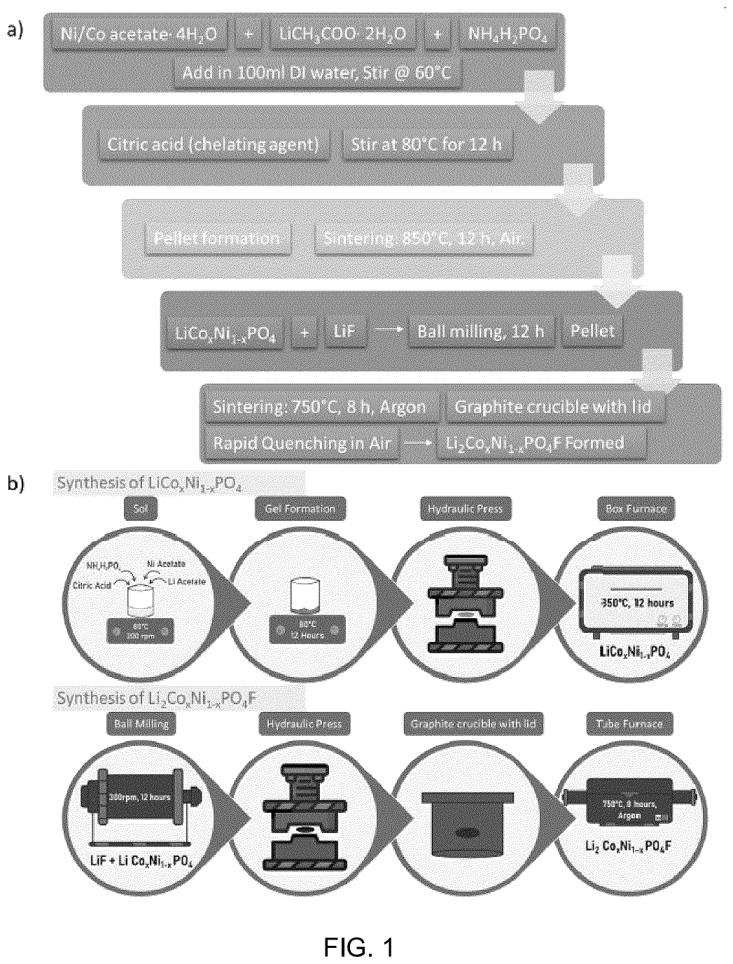

According to an embodiment of the present disclosure, three different substitutions, Li₂Co_{1/3}Ni_{2/3}PO₄F, Li₂Co_{1/2}Ni_{1/2}PO₄F, and Li₂CO_{2/3}Ni_{1/3}PO₄F, were investigated to compare the effect of Co substitution on the Li₂NiPO₄F and how electrochemical performance differs between these materials. This novel material and its synthesis procedure will also be covered in the scope of this disclosure. For example, the material was synthesized using a sol-gel and sintering route. FIG. 1 illustrates a) a flow chart and b) a schematic of the entire synthesis process of the LiCoₓNi₁₋ₓPO₄ material and the Li₂CoₓNi₁₋ₓPO₄F material.

According to an embodiment of the present disclosure, the synthesis of Li₂CoₓNi₁₋ₓPO₄F cathode material is a two-step process. LiCoₓNi₁₋ₓPO₄ material is synthesized during the first step, which is used as a precursor for the 2nd step. For example, firstly, 100 ml of DI water was heated in a glass beaker at 60° C. with continuous stirring. Then lithium, nickel, and cobalt acetate (Sigma Aldrich) were added to DI (Deionization) water and left for 30 minutes until it dissolved completely. Later, ammonium dihydrogen phosphate (NH₃H₂PO₄) (Sigma Aldrich) was added to the solution. Also, citric acid (Sigma Aldrich, ACS reagent ≥99.5%, metal ions to citric acid 1:1) was added to the precursor solution as a chelating agent. The temperature of the solution was then increased to 80° C. with continuous stirring for 12 hours to dry the precursor mixer completely. Once all the DI water was evaporated, the precursor mixer was ground and homogeneously mixed using agate mortar. The powder was then pressed into small pellets using stainless steel die of 10 mm diameter for sintering. The materials were sintered in air at 850° C. for 12 hours in a box furnace to synthesize phase pure LiCoₓNi₁₋ₓPO₄. After synthesizing LiCoₓNi₁₋ₓPO₄, during the 2nd step, it was mixed with stoichiometric amounts of LiF (Sigma Aldrich) using the ball milling technique. Zirconia balls were used as a grinding media. After the materials were ball milled for 12 hours, the material was collected and pressed into pellets for the final heat treatment process. The pellets were sintered in a graphite crucible covered with a lid at 750° C. for 8 hours under a continuous argon flow. Li₂CoₓNi₁₋ₓPO₄F material is quite unstable at room temperature and thus requires rapid air quenching. The top prevented and reduced the direct contact of Li₂CoₓNi₁₋ₓPO₄F with air and assisted in avoiding the decomposition during air quenching. After the material was quenched and cooled, the pellets were ground to powder for further processing.

According to an embodiment of the present disclosure, the material obtained by the synthesis method described herein can be further optimized with various strategies like surface coatings (ceramic materials such as CeO₂, SiO₂, etc.) and doping of other transition metals (Mn, V, etc.). This will improve the material's electrochemical properties and protect it from electrolyte decomposition during high voltage operations. Moreover, in-situ coating and doping processes can be introduced into the current invention during the 2nd heat treatment, stabilizing the material structure and reducing the additional coating and doping steps, thus reducing the material manufacturing cost. Such optimizations can be meaningful with a detailed electrochemical analysis and later optimizing the materials based on electrochemical results.

It should be noted that synthesized Li₂NiPO₄F and the newly synthesized Li₂CoₓNi₁₋ₓPO₄F materials have redox potential at 5.3 V. They can be suitable to run up to 6 V. However, these materials are currently limited due to the lack of high voltage electrolytes in Li-ion batteries. Current commercial electrolytes have limited electrochemical stability windows. Hence, these materials have a redox couple at 5.3 V and thus operate beyond the electrochemical stability window of the commercially available electrolyte, which results in enormous electrolyte oxidation during high voltage operation and, therefore, in side reactions at the cathode/electrolyte interface. With the development of new electrolytes and the optimization of currently available electrolytes, this issue will be solved in the future.

### Experimental Verification

The Disclosed Invention was experimentally-verified. The Li₂NiPO₄F and Li₂CoₓNi₁₋ₓPO₄F (x<1) cathode materials were synthesized and underwent various characterization techniques. Several characterization tools were used to characterize the material (Disclosed Invention), including x-ray diffraction (XRD) to evaluate the purity of synthesized materials and scanning electron microscopy (SEM) to analyze particle morphology (size, shape, distribution).

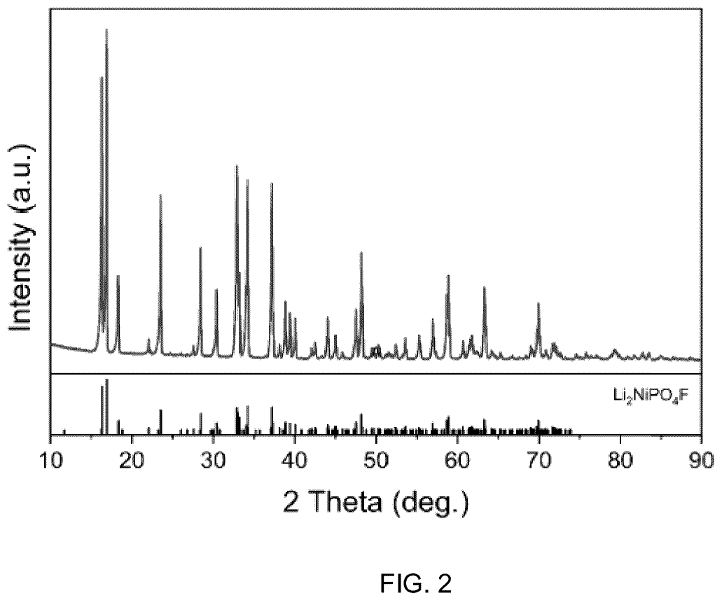

Powder x-ray diffraction analysis (PAN Analytical-Empyrean) was used for crystal structure and phase purity analysis. The sample scan range and the step size were 10≤2θ≤90° and 0.01313°, respectively, utilizing Cu-Kα radiation (1.5425 Å) at room temperature. XRD spectra illustrated in FIG. 2 shows the development of pure phase material. The Li₂NiPO₄F material can be identified in the orthorhombic crystal system and the Pnma space group.

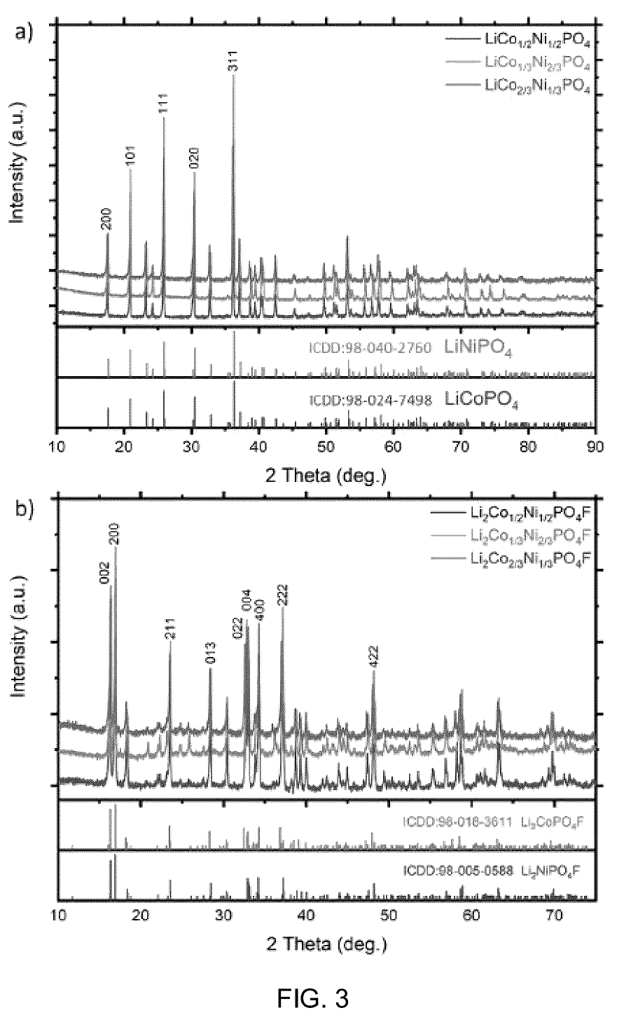

The XRD spectra for the precursor material and the final cathode materials are illustrated in FIG. 3. With the precursor material and the Li₂CoₓNi₁₋ₓPO₄F cathode materials, indexing shows phase pure material development. FIG. 3, graph a, shows the XRD spectra of the precursor materials LiCo_{1/3}Ni_{2/3}PO₄, LiCo_{1/2}Ni₂PO₄, and LiCo_{2/3}Ni_{1/3}PO₄. The synthesized materials were indexed to both databases LiCoPO₄ and LiNiPO₄ with ICSD codes 98-024-7498 and 98-040-2760, respectively. A slight shift was observed in the XRD spectra of the different samples correlating with the contraction and expansion of the unit cell with varying concentrations of Co and Ni used. FIG. 3, graph b shows XRD spectra of the final cathode materials Li₂Co_{1/3}Ni_{2/3}PO₄F, Li₂Co_{1/2}Ni_{1/2}PO₄F, and Li₂Co_{2/3}Ni_{1/3}PO₄F. The final cathode materials were indexed to the database materials Li₂CoPO₄F and Li₂NiPO₄F with ICSD codes 98-018-3611 and 98-005-0588, respectively. One significant observation is the presence of some impurity phases in the spectra. However, the current impurity phases tend not to significantly affect the electrochemical behavior of these cathode materials based on the electrochemical tests conducted.

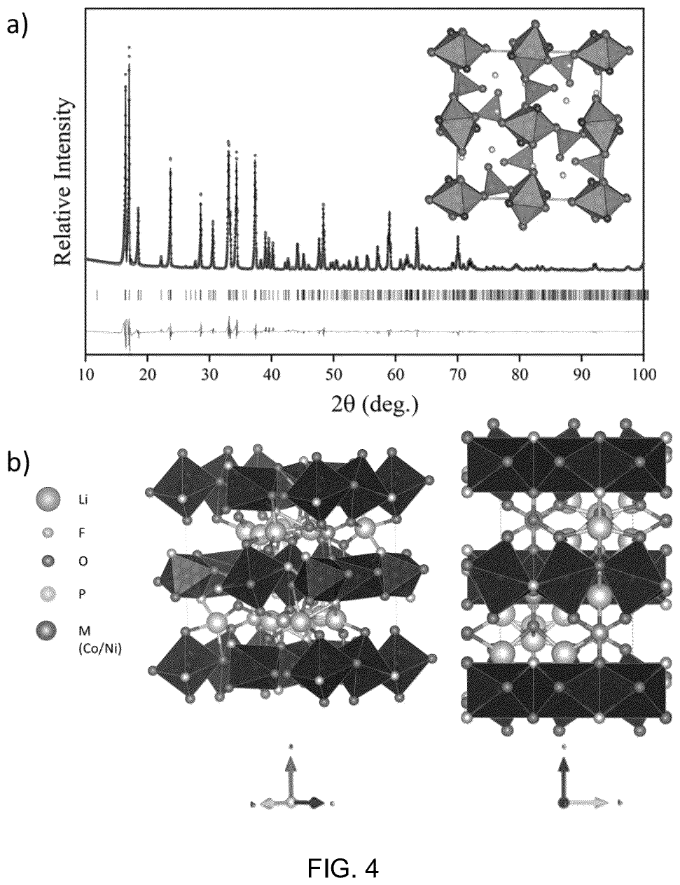

The synthesized material's phase purity was verified by using Rietveld refinement, as shown in FIG. 4, graph a. The refinement gave lattice parameter values a, b, and c 10.4557 Å, 6.2779 Å, and 10.8326 Å, respectively. From the lattice parameter data, the calculated cell volume is 711.2766 Å3. The inset of FIG. 4 graph a shows the crystal structure of the synthesized material Li₂NiPO₄F material. The proposed crystal structure for Disclosed Invention, Li₂CoₓNi₁₋ₓPO₄F (x<1) cathode material, is shown in FIG. 4, portion b, where the only significant difference is that the MO6 octahedra will host either Co or Ni-based on the different concentrations utilized.

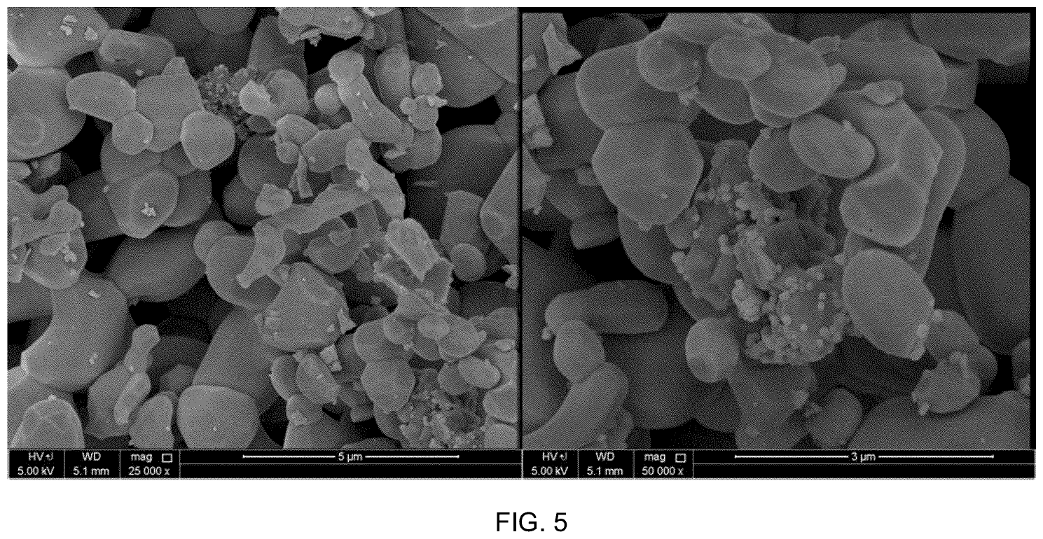

The morphology and the particle size distribution were confirmed using the SEM. The SEM images are illustrated in FIG. 5. SEM revealed the synthesis of the submicron-sized Li₂NiPO₄F material with homogeneous particle size distribution. The size of primary particles is between 0.5-1.2 μm.

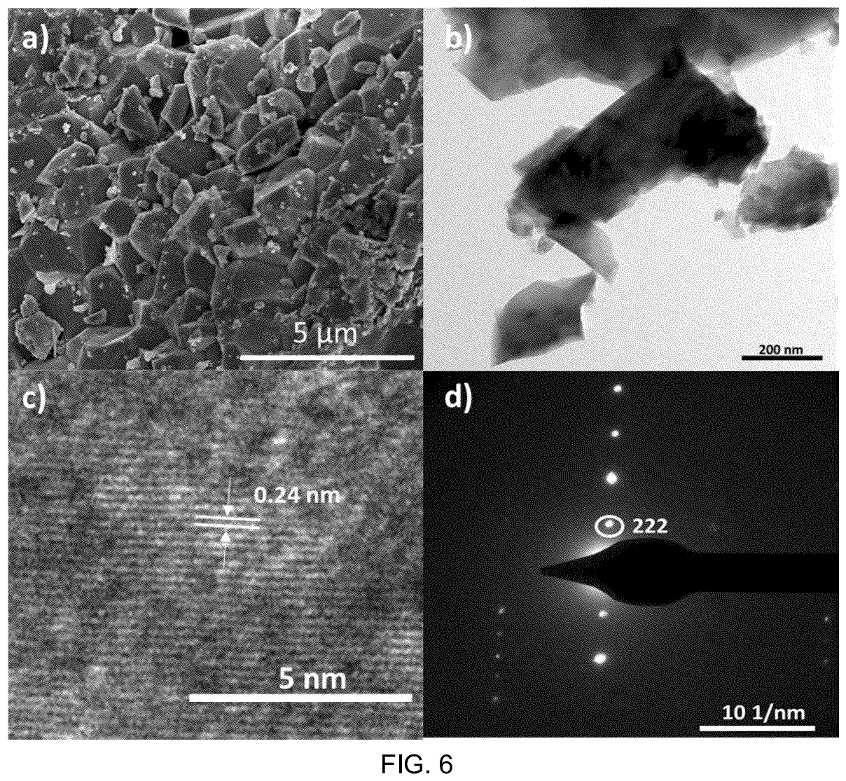

The SEM images of the Li₂Co_{1/2}Ni_{1/2}PO₄F cathode material are illustrated in FIG. 6, portion a. SEM revealed the synthesis of the micron-sized Li₂Co_{1/2}Ni_{1/2}PO₄F material with homogeneous particle size distribution. The size of primary particles is between 0.5-1.2 μm. There is a uniform distribution of the particles. Some sub-micron particles are also observed in the SEM, which can be carbon obtained from the sol-gel process employed during the synthesis of this material. FIG. 6, portion b, shows the HR-TEM images of the synthesized Li₂Co_{1/2}Ni_{1/2}PO₄F material. Here, particles with a size of 0.5 μm and above were observed correlating with the SEM images. Through TEM, the lattice fringes of the material were calculated (seen in FIG. 6, portion c) and found to be 0.24 nm, a d-spacing value of 2.4 Å matching with the [222] plane of the crystal structure. The selected area electron diffraction (SAED) pattern was also conducted and shown in FIG. 6, portion d. Here the pattern can be indexed to the [222] plane based on the d-spacing value of 2.35 Å calculated from the pattern. It needs to be noted that the synthesized materials were susceptible to the electron beam and decomposed rapidly when exposed to the electron beam.

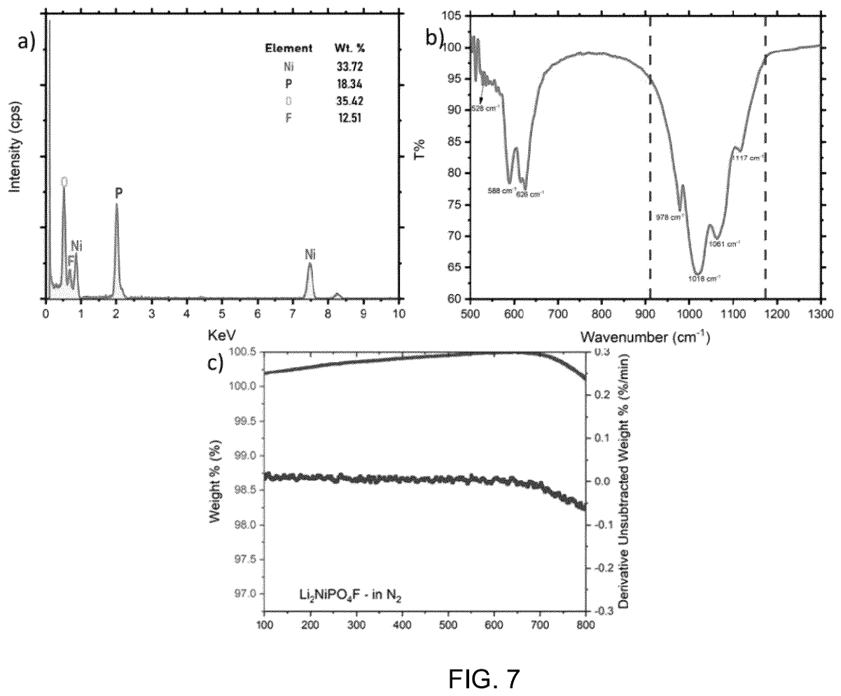

The composition of the developed material was also confirmed using EDX analysis. FIG. 7, graph a, shows the EDX analysis of the synthesized Li₂NiPO₄F sample. Table 1 compares the average atomic weight distribution of the actual synthesized material and their theoretical values. The actual values match the theoretical values confirming the pure phase formation of Li₂NiPO₄F material. To further characterize the synthesized material, FTIR analysis was conducted. FIG. 7, graph b, shows the FTIR spectra of the synthesized Li₂NiPO₄F cathode material. The region from 500-1200 cm-1 fundamentally represents the PO43-anionic species. The PO43-anionic species usually has four vibrational nodes depicted in this region because of the correlation developed from the Ni—O bond coupling. The entire FTIR spectra of Li₂NiPO₄F mainly cover the vibrational spectra of PO43-anionic species. Here, the prominent peaks observed at 978, 1018, 1061, and 1117 cm-1 correlate with PO43-anionic species at the v1 and v3 bands, the peaks observed at 588 and 626 cm-1 represent the v4 band of the PO43-anionic species, and the prominent peaks at 528 and 535 cm-1 are attributed to the asymmetric Ni—O bond stretching in NiO6 octahedra suggesting high crystallinity. The thermogravimetric analysis (TGA) curves of the synthesized material Li₂NiPO₄F are shown in FIG. 7, graph c. The TGA was performed from 100° C. to 800° C. in the presence of nitrogen. TGA results revealed slight weight loss after 656° C. for Li₂NiPO₄F. This ensures excellent intrinsic thermal stability of the Li₂NiPO₄F material. At 656° C., the weight loss results from the decomposition of Li₂NiPO₄F into LiNiPO₄ and Li₃PO₄ phases.

TABLE 1
Comparison of Theoretical and Actual wt. %
values of the Li₂NiPO₄F material

| Element | Theoretical Atomic wt. % | Actual Atomic wt. % |
|---|---|---|
| Li | 7.4 | Not Detected |
| Ni | 31.4 | 33.7 |
| P | 16.6 | 18.3 |
| O | 34.3 | 35.4 |
| F | 10.2 | 12.5 |

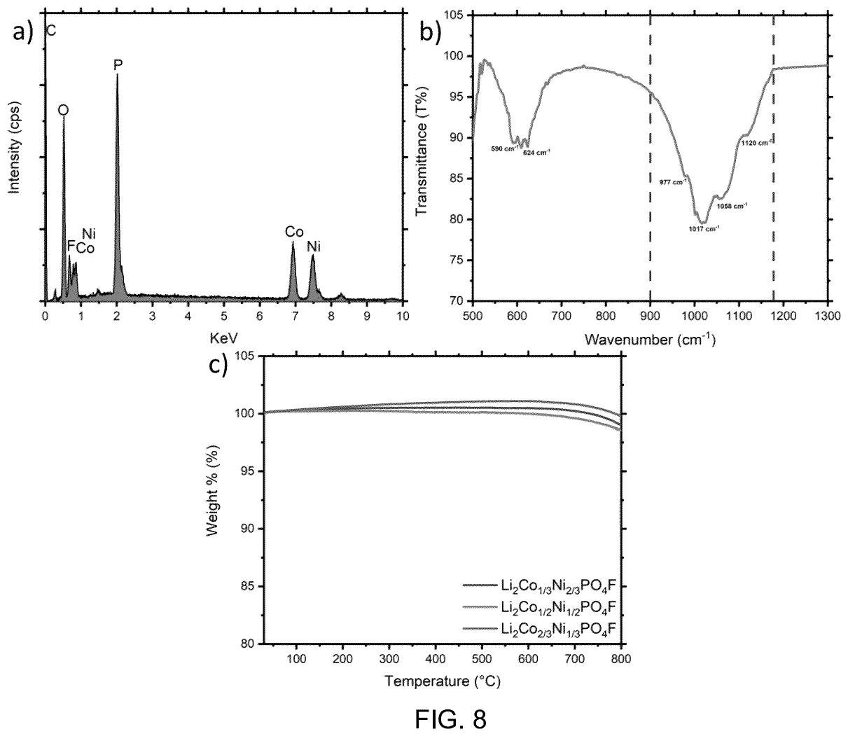

The composition of the developed material was also confirmed using EDX analysis. FIG. 8a shows the EDX spectrum of the synthesized Li₂Co_{1/2}Ni_{1/2}PO₄F sample. The EDX spectrum shows the presence of all the significant elements Co, Ni, P, O, and F, with no other element observed. This confirms the formation of Li₂Co_{1/2}Ni_{1/2}PO₄F material with evidence provided in previous characterizations. Table 2 compares the average atomic weight distribution of the actual synthesized material and their theoretical values. The actual values conform to the theoretical values confirming the formation of Li₂Co_{1/2}Ni_{1/2}PO₄F material. To further characterize the synthesized material, FTIR analysis was conducted. FIG. 8, graph b, shows the FTIR spectra of the synthesized Li₂Co_{1/2}Ni_{1/2}PO₄F cathode material. The region from 500-1200 cm-1 fundamentally represents the PO43-anionic species. The PO43-anionic species usually has four vibrational nodes depicted in this region due to correlation developed from the TM-O bond coupling. The entire FTIR spectra of Li₂Co_{1/2}Ni_{1/2}PO₄F mainly cover the vibrational spectra of PO43-anionic species. Here, the prominent peaks observed at 977, 1017, 1058, and 1120 cm-1 correlate with PO43-anionic species at the v1 and v3 bands, the peaks observed at 590 and 624 cm-1 represent the v4 band of the PO43-anionic species, and the main peaks at 528 and 535 cm-1 are attributed to the asymmetric TM-O bond stretching in (T.M.)O₆ octahedra suggest high crystallinity. The thermogravimetric analysis (TGA) curves of the synthesized material Li₂CoₓNi₁₋ₓPO₄F (x<1) cathode materials are shown in FIG. 8, graph c. The TGA was performed from 30° C. to 800° C. in the presence of nitrogen. TGA results revealed slight weight loss only after 656° C. for all the cathode materials. This ensures excellent intrinsic thermal stability of the Li₂CoₓNi₁₋ₓPO₄F (x<1) cathode materials. At 656° C., the weight loss results from the decomposition of Li₂CoₓNi₁₋ₓPO₄F into LiCoₓNi₁₋ₓPO₄ and Li₃PO4 phases.

TABLE 2
Comparison of Theoretical and Actual wt. % values
of the Li₂Co_{1/2}Ni_{1/2}PO₄F material.

| Element | Theoretical Atomic wt. % | Actual Atomic wt. % |
|---|---|---|
| Li | 7.4 | Not Detected |
| Ni | 15.7 | 16.6 |
| Co | 15.8 | 17.9 |
| P | 16.5 | 14.5 |
| O | 34.3 | 35.8 |
| F | 10.2 | 11.5 |

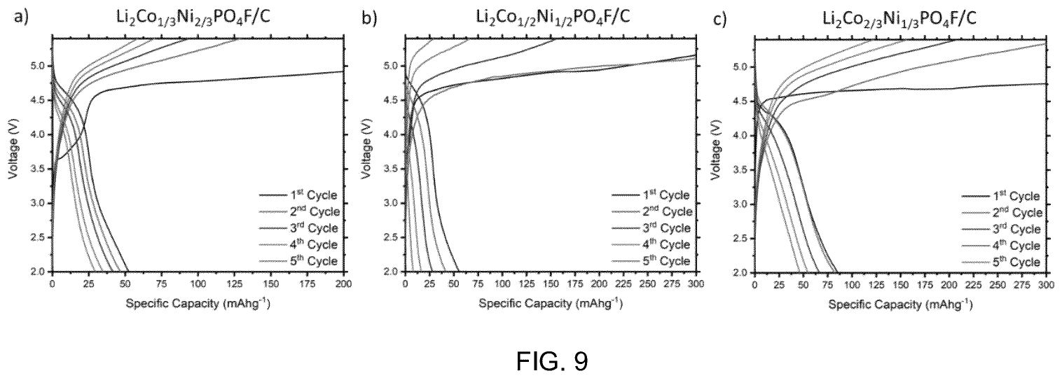

The cycling behavior of the Li₂CoₓNi₁₋ₓPO₄F (x<1) cathode materials assembled using a polymer separator at a C/20 rate is shown in FIG. 9. Here, only five cycles are offered due to electrolytes rapidly degrading with each cycle. The 1M LiBF₄ in E.C.:DMC: Sebaconitrile (25/25/50 w/w %) electrolyte seems to degrade rapidly when the cell reaches 5.4 V. This leads to extreme capacity fade with each cycle. All three prepared cathode samples show irreversible 1st charge cycle capacity. This is due to electrolyte degradation at high voltage and deposited onto the active electrode material. However, with repeated cycles, the irreversible charge capacity is minimized. Another major observation is the lack of discharge plateaus suggesting a different (de)intercalation behavior from the general olivine materials. With capacity performance, the Li₂Co_{2/3}Ni_{1/3}PO₄F cathode material (FIG. 9, graph c) showed the best performance out of the three materials in the Celgard 2300 polymer separator category. The initial discharge capacity has a value of 86 mAhg⁻¹, and the corresponding cycle has a value of 84 mAhg⁻¹. Although initial capacity values for the Li₂Co_{2/3}Ni_{1/3}PO₄F cathode material are significant, after five cycles, the capacity fades to just 49 mAhg⁻¹ suggesting extreme capacity fade. This is also observed in the other cathode materials. The Li₂Co_{1/2}Ni_{1/2}PO₄F cathode material (FIG. 9, graph b) shows an initial discharge capacity of 56 mAhg⁻¹, and after five cycles, it decreases to just 9 mAhg−1. With Li₂Co_{1/3}Ni_{2/3}PO₄F cathode material (FIG. 9, graph c), the initial discharge capacity is 53 mAhg⁻¹, and after five cycles, it decreases to 34 mAhg⁻¹.

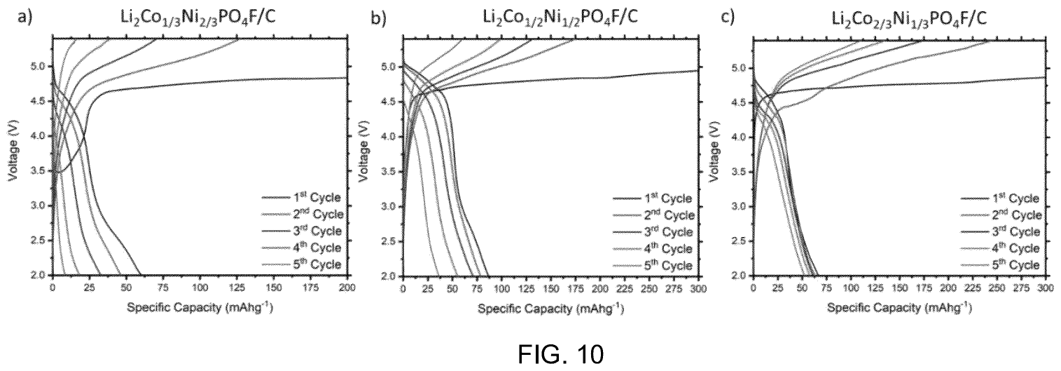

FIG. 10 shows the galvanostatic charge-discharge behavior of the synthesized Li₂CoₓNi₁₋ₓPO₄F (x<1) cathode materials with the Whatman glass fiber (GF/D) separators at a C/20 rate. Some similar behaviors are observed between the glass fiber and polymer separator assembled cells. The irreversible 1st charge cycle capacity is also observed with these cells, correlated to the electrolyte degradation at high voltage (5.4 V). Like the polymer separators, significant capacity fade is observed in these materials with each cycle. One outlier for this is the Li₂Co_{2/3}Ni_{1/3}PO₄F cathode material (FIG. 10, graph c). Although the initial discharge capacity of this material is only 67 mAhg⁻¹, the capacity fade observed is significantly lower than the other materials. After five cycles, the Li₂Co_{2/3}Ni_{1/3}PO₄F cathode material maintained a discharge capacity of 53 mAhg⁻¹. This can be due to less cathode active material decomposition and electrolyte decomposition. On comparing the discharge capacities of the other materials, the Li₂Co_{1/2}Ni_{1/2}PO₄F cathode material (FIG. 10, graph b) had the highest discharge capacity, 87 mAhg⁻¹; however, it showed high-capacity fade and only showed a discharge capacity of 36 mAhg⁻¹ after five cycles. The Li₂Co_{1/3}Ni_{2/3}PO₄F cathode material (FIG. 10, graph a) showed the worst performance of all three cathode materials with the glass fiber separator. The material showed an initial discharge capacity of only 60 mAhg⁻¹; after five cycles, the capacity faded to just 9 mAhg⁻¹. Overall, the Li₂Co_{1/2}Ni_{1/2}PO₄F cathode material showed the best capacity values; however, the Li₂Co_{2/3}Ni_{1/3}PO₄F cathode showed the best capacity retention.

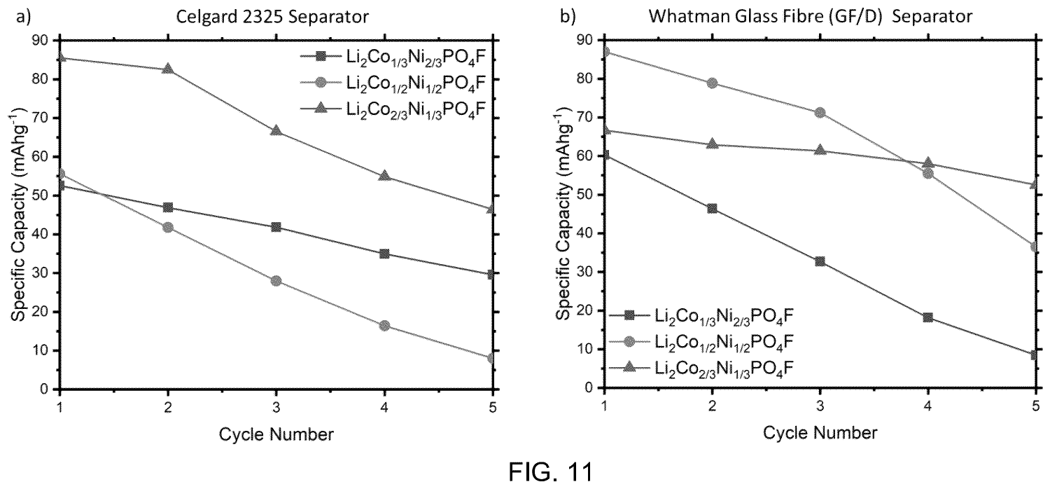

The cycling behavior of the Li₂CoₓNi₁₋ₓPO₄F (x<1) cathode materials at C/20 rate, assembled with the Celgard 2325 separator and Whatman Glass Fibre (GF/D) separator are shown in FIG. 11. As discussed in the galvanostatic charge-discharge section, significant capacity fade is the major factor observed in all the cathode materials. Electrolyte degradation at high voltage is the most common cause of this behavior with these cathode materials. The Ni concentration also plays a role in the poor capacity performance of these materials. The cathode material with high Ni concentration showed poor performance in cells assembled with either separator. This poor electrochemical behavior in high Ni concentration samples can be attributed to either low ionic conductivity with the parent Li₂NiPO₄F sample or the complete decomposition of the material at high redox potentials, as shown here. When decreasing the concentration of Ni and increasing Co concentration, the discharge capacity values tend to increase. However, significant capacity fade is still observed in these materials. The continuous reaction of the electrolyte with the active material surface, thereby decomposing the active cathode material, is another factor contributing to the poor cycling stability of these cathode materials. Hence, to ideally test these novel cathode materials, a more stable high voltage electrolyte capable of forming structurally stable solid electrolyte interphase (SEI) layers are required to accurately test the electrochemical performance of any future high voltage electrode materials.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A synthesis method of cathode material, comprising:
dissolving lithium, nickel and cobalt acetate in a solution,
adding ammonium dihydrogen phosphate to the solution,
adding acid to the solution,
heating the solution to a first temperature for a first period of time to form a solid mixer material, and
sintering the solid mixer material at a second temperature for a second period of time.

2. The synthesis method of claim 1, further comprising ball milling the sintered solid mixer material with lithium fluoride to form a plurality of pellets.

3. The synthesis method of claim 1, further comprising sintering the plurality of pellets at a third temperature for a third period of time.

4. The synthesis method of claim 1, wherein the first temperature is lower than the second temperature.
